(19) United States
(12) Patent Application Publication
(10) Pub. No.: US 2007/0023947 A1
(43) Pub. Date: Feb. 1, 2007

(54) Method of producing a foamed part and foaming tool for applying such method

(76) Inventors: Matthias Ludwig, Vechelde (DE); Herbert Beck, Wolfenbuettel (DE); Harald Batke, Mueden/Aller (DE); Frank Niebuhr, Wilsche (DE); Hans-Joachim Langhoff, Gifhorn (DE); Sven Hardel, Wettendorf (DE); Tobias Niesner, Gifhorn (DE)

Correspondence Address: CARLSON, GASKEY & OLDS, P.C., 400 WEST MAPLE ROAD, SUITE 350, BIRMINGHAM, MI, 48009, US

(21) Appl. No.: 11/488,951

(22) Filed: Jul. 19, 2006

(30) Foreign Application Priority Data
Jul. 28, 2005 (EP) 05 016 405.2

(51) Int. Cl. B29C 44/12

(52) U.S. Cl. 264/46.4; 425/289

(57) ABSTRACT

A method of producing a foamed part, in particular a car body attachment part for a motor vehicle, includes the following steps. A foaming tool is provided that includes a tool bottom part and a tool upper part. An outer skin is placed in the tool bottom part and an expandable material is applied. The foaming tool is closed, with at least one portion of the outer skin being located in a gap between the tool bottom part and the tool upper part. After the foaming process, during opening of the foaming tool, the outer skin is trimmed by the foaming tool itself. The invention further relates to a foaming tool for applying such a method.

### RELATED APPLICATIONS

The application claims priority to European Patent Application No. 05 016 405.2 which was filed on 28 Jul. 2005.

### BACKGROUND OF THE INVENTION

The invention relates to a method of producing a foamed part, in particular a car body attachment part for a motor vehicle, and further to a foaming tool for applying such method.

Car body attachment parts for a motor vehicle are parts that are attached to a vehicle body. These parts define at least portions of an outer skin of a vehicle in the readily mounted state, and are visible from outside of the vehicle. Car body attachment parts may be flaps (doors, lids), bumpers, or roof modules, for example. Roof modules having a sliding roof unit would also comprise a car body attachment part.

Foamed car body attachment parts, in particular roof modules, comprising a glass-fiber reinforced polyurethane (PU) material are already known, with glass fibers being injected in plastic using a so-called long fiber injection method (LFI method). A deep-drawn foil outer skin, which consists of plastic or aluminum and has a thickness of 0.5 to 2 mm, is placed in a foaming tool and is provided with a foamed backing. When the PU material has reacted to foam, the car body attachment part has to be taken out of the foaming tool and an edge thereof has to be trimmed by milling or with a water jet in order to remove excess material and produce a dimensionally accurate cutting rim (cut edge). The trimming of the car body attachment part is done in a separate work step, which increases cost.

It is the object of the invention to provide a method of producing a foamed part and a foaming tool for applying such method, so that the foamed part can be produced at low costs and in a simple manner.

### SUMMARY OF THE INVENTION

This is achieved by a method, according to the invention, of producing a foamed part, in particular a car body attachment part for a motor vehicle, which comprises the following steps: providing a foaming tool including a tool bottom part and a tool upper part; placing an outer skin in the tool bottom part; applying an expandable material; and closing the foaming tool, with at least one portion of the outer skin being located in a gap between the tool bottom part and the tool upper part, and after the foaming process and during opening of the foaming tool, the outer skin is trimmed by the foaming tool itself.

The outer skin, which for instance is a deep-drawn foil of plastic or aluminum and has a thickness of 0.5 to 2 mm, is placed in a foaming chamber that is a cavity between the tool bottom part and the tool upper part. The outer skin has at least one portion extending in a gap between the tool bottom part and the tool upper part. As the foaming tool is opened, the outer skin is trimmed by the foaming tool itself, which has a section with a cutting rim. Any subsequent trimming of the outer skin is not necessary, so that the production method of the car body attachment part is simpler and more cost-efficient. If there is foaming material in the gap between the tool bottom part and the tool upper part, any such material will also be trimmed during opening of the foaming tool.

The invention could be applied with an injection-molding tool as well, and the car body attachment part could be injection-molded.

It is preferred that one of the tool parts has a cutting edge by which the outer skin is trimmed. During opening of the foaming tool, i.e. shifting of one of the tool parts, for instance shifting the tool upper part in an opening direction, the outer skin is trimmed by this cutting edge, and if applicable, any cured foam material that is present in the gap between the tool bottom part and the tool upper part.

The cutting edge is preferably exchangeable. The cutting edge is a wear and tear element that is part of a cutting insert. When worn out, the entire tool part need not be replaced; it will only be necessary to attach a new cutting insert to the tool part.

The outer skin is, for instance, trimmed between a supporting surface on one tool part and the cutting edge on the other tool part. The supporting surface is preferably exchangeable. The supporting surface is a wear and tear element.

It will be preferred that the cutting edge and an outer edge of the supporting surface are essentially superimposed in an opening direction in a closed condition of the foaming tool. During opening of the foaming tool, the outer edge of the supporting surface and the cutting edge are closely moved past each other, so that only a minimum gap remains between the cutting edge and the outer edge of the supporting surface, guaranteeing a straight cutting rim without any protruding excess material.

One of the tool parts, for instance, has an appendage. Laid around this appendage is a portion of the outer skin that adjoins a cutting rim. The cutting rim is created during trimming of the outer skin.

The cutting edge is preferably located in a region of the appendage. If the cutting edge is configured to be exchangeable, the appendage may also be designed to be exchangeable.

According to a preferred embodiment, one of the tool parts has a slider comprising the supporting surface or the cutting edge. The slider can be displaced in a direction transverse to the opening direction in order to allow insertion of the outer skin and, after insertion of the outer skin, to move those surfaces on the tool parts close to each other between which the outer skin will be trimmed afterwards.

It is preferred that one of the tool parts has an undercut adjacent to the appendage, with the outer skin extending as far as to the gap along the undercut. The undercut and the appendage may be configured such that expandable material can flow into a region between the undercut and the appendage. Thus, material that is cured after foaming as well as the outer skin are located in the gap and will be trimmed in common. The gap is part of the foaming chamber that is defined as a cavity between the tool upper part and the tool bottom part, and which also provides ventilation.

Preferably, in a region of the gap, the outer skin is clamped between the tool upper part and the tool bottom part. The outer skin is pressed by one part (e.g. tool bottom part) against a second part (e.g. tool upper part), so that a little amount of foaming material can escape in a defined manner between the outer skin, tool bottom part and tool upper part.

The foaming tool according to the invention for applying this method has a tool bottom part, a tool upper part and a foaming chamber between the tool bottom part and the tool upper part. The tool bottom part and the tool upper part have a cutting edge and a supporting surface that are located at an edge of the foaming chamber. The cutting edge and supporting surface are essentially superimposed in an opening direction, and are closely moved past each other during opening in order to trim an edge of the foamed part. Due to the positioning of the cutting edge relative to the supporting surface, in particular relative to an outer edge of the supporting surface, an outer skin is sheared off during opening of the foaming tool. The outer skin that is sheared off is in fact the outer skin that was previously placed in the foaming chamber, i.e. in a cavity between the tool bottom part and the tool upper part, and was provided with a foamed backing. In this process, a straight cutting rim on the outer skin will be created. Trimming of the car body attachment part after foaming in a separate work step is thus eliminated to provide reduced production effort, and to provide a car body attachment part that is cost-efficient and easy to manufacture.

It is preferred that one of the tool parts has the cutting edge that is arranged on an appendage.

It is preferred that one of the tool parts has an undercut, the outer skin extending into the undercut as far as to the gap when the foaming tool is closed.

Preferably, a gap is formed between the tool bottom part and the tool upper part. The outer skin is clamped in the region of the gap when the foaming tool is closed, with the region of the gap having two opposite surfaces that have the same inclination.

One of the tool parts preferably has a slider comprising one of the supporting surface and the cutting edge, with the slider being displaced in a direction transverse to the opening direction.

These and other features of the present invention can be best understood from the following specification and drawings, the following of which is a brief description.

### BRIEF DESCRIPTION OF THE DRAWINGS

FIG. 1 is a perspective view of a motor vehicle including a car body attachment part in the form of a roof module produced according to a method according to the invention, with a foaming tool of the invention being employed.

FIG. 2 is a sectional view of the car body attachment part along line II-II in FIG. 1.

FIG. 3 is a sectional view through the car body attachment part in the foaming tool according to the invention.

FIG. 4 shows an enlarged detail of the area in FIG. 3 designated with X.

### DETAILED DESCRIPTION OF THE PREFERRED EMBODIMENT

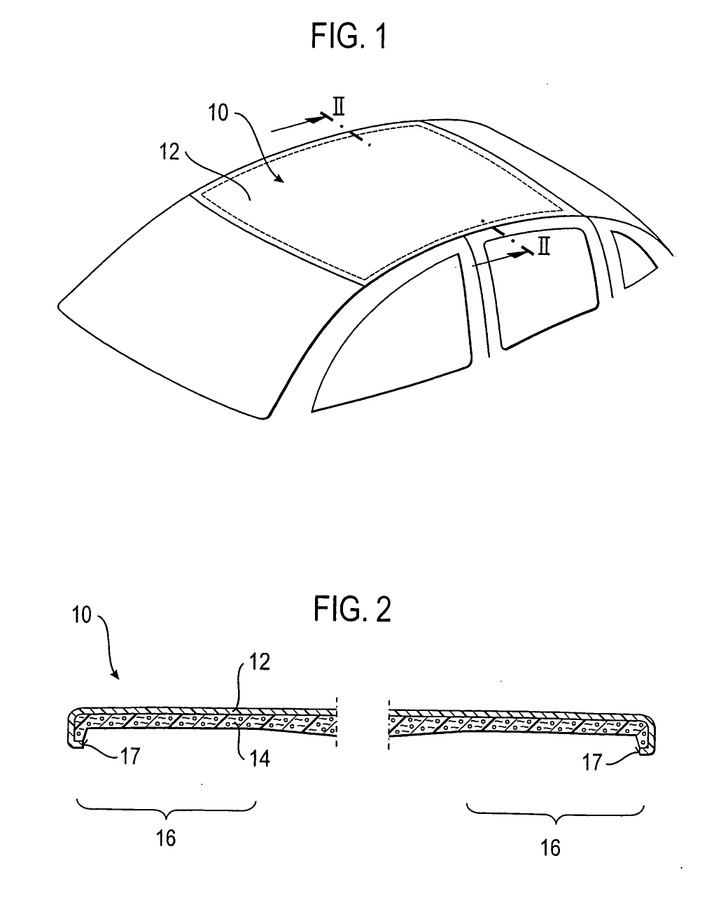

FIG. 1 shows a foamed part, to be more precise a car body attachment part, in the form of a roof module 10. The car body attachment part, however, could also be configured as a fender, door or flap (engine hood, trunk lid) of a motor vehicle. A lining part for a vehicle interior space could also be produced by the following method.

When mounted to the vehicle, the roof module 10 has a visible outside which is formed by a thin, deep-drawn foil outer skin (outer skin 12). The outer skin 12 is made of plastic or aluminum and preferably is dyed throughout and coated, respectively, to replace an outside painting.

Directly adjoining the backside of the outer skin 12 there is a plastic layer 14 that is constituted by a fiber-reinforced PU foam, and which is formed by providing the outer skin 12 with a foamed or injection-molded backing, with the glass fibers being introduced in the foam by the LFI method to reinforce the plastic layer 14 (FIG. 2).

The plastic layer 14 shown in FIG. 2 has a larger thickness in a middle region than in border areas 16 as seen in a longitudinal direction of the vehicle. Both side edges of the roof module 10 protrude beyond a lower edge that is formed by the middle region of the plastic layer 14, with the outer skin 12 being bent around the protruding side edges of the roof module 10. A cutting rim of the outer skin 12 is designated by reference numeral 17

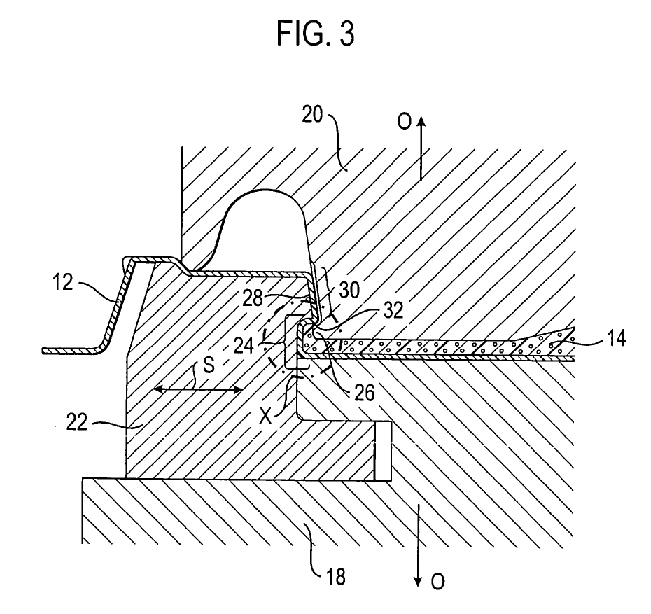

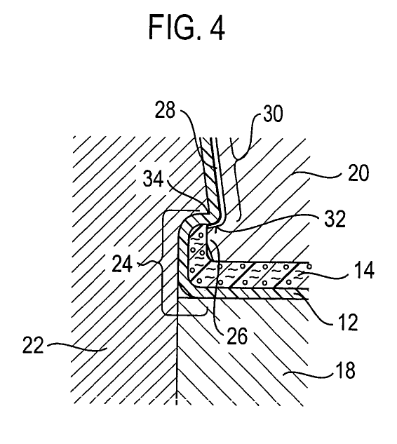

FIGS. 3 and 4 show the foaming tool used to produce the roof module 10. The foaming tool includes a tool bottom part 18 and a tool upper part 20.

The tool bottom part 18 has a two-part configuration and includes a slider 22. An opening direction O of the tool bottom part 18 and the tool upper part 20 is vertical as shown by arrow O of FIG. 3. Opening directions of the slider 22 are transverse to the opening direction O of the foaming tool, i.e. horizontal as indicated by arrow S.

The outer skin 12 abuts on an undercut 24 of the slider 22 and extends around an appendage 26 of the tool upper part 20 in a gap 28 between the slider 22 and the tool upper part 20.

It is in a region of the gap 28 that the outer skin 12 is clamped between the slider 22 and the tool upper part 20, which have the same inclination in this region.

The outer skin 12 extends along an upper edge of the slider 22 and is clamped at a point between the slider 22 and the tool upper part 20.

The appendage 26 on the tool upper part 20, adjoining the undercut 24 of the slider 22, has a cutting edge 32 that is part of an exchangeable cutting insert. It is also possible to exchange the appendage 26 together with the cutting edge 32. Situated above the appendage 26 (in opening direction O) is an outer edge of a supporting surface 34 (FIG. 3) of the slider 22, the function of which will be explained below.

During production of the roof module 10, the preformed outer skin 12 is placed in the tool bottom part 18 with the slider 22 being shifted outwards, and with the outer skin 12 resting at the tool bottom part 18. Liquid PU material will then be applied to a backside of the outer skin 12, with glass fibers being enclosed (LFI method) in the course of this. The tool upper part 20 is shifted downward and the slider 22 is shifted inward to the closed position. The PU material reacts to foam and fills a foaming chamber formed between the tool bottom part 18 and the tool upper part 20. The foaming chamber forms the plastic layer 14 after foaming.

When the tool upper part 20 is opened in the opening direction O, which is vertical in this embodiment, the outer skin 12 is trimmed by the cutting edge 32 in a horizontally extending portion of the gap 28. The slider 22 remains in the closed position during opening of the tool upper part 20, so that the supporting surface 34 on the slider 22 stays in position and can not “slip away.” This produces a straight cutting rim 17. As an edge of the supporting surface 34 lies above the cutting edge 32, and as the latter is closely moved past the edge of the supporting surface 34 during opening, excess material will not be left behind. Thus, a clean cutting rim 17 is achieved that does not require any subsequent processing.

The undercut 24 and the appendage 26 are configured in this example such that only a defined amount of foaming material will reach the gap 28 between the appendage 26 and the supporting surface 34. This is why the outer skin 12, as well as the foaming material that arrives at the gap 28, will be sheared off during opening of the tool upper part 20. The foaming material is not shown in the gap 28.

If the undercut 24 extends farther upward (according to FIG. 3), then a larger amount of foaming material, which forms the plastic layer 14, would enter the space between the supporting surface 34 and the cutting edge 32, and the plastic layer 14 together with the outer skin 12 would be sheared off in one step.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A method of producing a foamed car body attachment part for a motor vehicle comprising the following steps:
a) providing a foaming tool including a tool bottom part and a tool upper part;
b) placing an outer skin in the tool bottom part;
c) applying an expandable material; and
d) closing the foaming tool, with at least one portion of the outer skin being located in a gap between the tool bottom part and the tool upper part, and after foaming and during opening of the foaming tool, the outer skin is trimmed by the foaming tool itself.

2. The method according to claim 1 wherein one of the tool upper part and the tool bottom part has a cutting edge that trims the outer skin.

3. The method according to claim 2 wherein the cutting edge is exchangeable.

4. The method according to claim 2 including trimming the outer skin between a supporting surface and the cutting edge.

5. The method according to claim 4 wherein the supporting surface is exchangeable.

6. The method according to claim 4 wherein the cutting edge and an outer edge of the supporting surface are essentially superimposed in an opening direction in a closed condition of the foaming tool.

7. The method according to claim 1 wherein one of the tool upper part and tool bottom part has an appendage, and including laying a portion of the outer skin that adjoins a cutting rim around the appendage, and creating the cutting rim during trimming of the outer skin.

8. The method according to claim 7 wherein the cutting edge is located in a region of the appendage.

9. The method according to claim 1 wherein one of the tool upper part and tool bottom part has a slider comprising one of a supporting surface and a cutting edge, the slider being displaced in a direction transverse to an opening direction during a foaming process.

10. The method according to claim 7 wherein one of the tool upper part and tool bottom part has an undercut adjacent to the appendage, the outer skin extending as far as to the gap along the undercut.

11. The method according to claim 1 wherein in a region of the gap the outer skin is clamped between the tool upper part and the tool bottom part.

12. A foaming tool for producing a foamed car body attachment part for a motor vehicle comprising:
a tool bottom part;
a tool upper part; and
a foaming chamber between the tool bottom part and the tool upper part, wherein the tool bottom part and the tool upper part each at least have one of a cutting edge and a supporting surface that are located at an edge of the foaming chamber, are essentially superimposed in an opening direction, and are closely moved past each other during opening in order to trim an edge of the foamed part.

13. The foaming tool according to claim 12 wherein one of the tool upper part and tool bottom part has the cutting edge, and wherein the cutting edge is arranged on an appendage.

14. The foaming tool according to claim 12 wherein an edge of one of the tool upper part and tool bottom part has an undercut in the foaming chamber, the foamed part extending into the undercut when the foaming tool is closed.

15. The foaming tool according to claim 12 wherein a gap is formed between the tool bottom part and the tool upper part, an outer skin of the foamed part being clamped in a region of the gap when the foaming tool is closed, with the region of the gap having two opposite surfaces that have the same inclination.

16. The foaming tool according to claim 12 wherein one of the tool upper part and tool bottom part has a slider comprising one of the supporting surface and the cutting edge, with the slider being displaced in a direction transverse to the opening direction.
